(19) United States
(12) Patent Application Publication
(10) Pub. No.: US 2003/0217443 A1
(43) Pub. Date: Nov. 27, 2003

(54) Fastening elastic cord

(76) Inventor: An-Chuan Chou, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/151,143

(22) Filed: May 21, 2002

(51) Int. Cl. B65D 63/10; A44B 21/00; F16G 11/00

(52) U.S. Cl. 24/300

(57) ABSTRACT

A fastening elastic cord includes an elastic cord portion, two end hooking elements, and a movable hooking element. Each of the hooking elements has a holding portion having a lateral opening, and a through hole. Two ends of the cord portion are passed through the through holes, and are formed with knots that are bigger than the through holes. The knots are protected with the respective holding portions when the fastening cord is used. The movable hooking element is movably fitted around an intermediate portion of the cord portion so that length of two sections of the cord at two sides of the movable element can be adjusted.

The hooking elements are each provided with a flexible plate that can engage the hooked portion to secure the connection of the hooking elements and a luggage trolley.

### BACKGROUND OF THE INVENTION

The present invention relates to a fastening elastic cord, more particularly a fastening elastic cord, which is provided for use with a luggage trolley, and which is equipped with hooking elements that can't fall off the cord portion or the luggage trolley.

Referring to FIGS. 5, and 6, a conventional fastening elastic cord 5 includes an elastic cord portion 51, and two hooking elements 52. The hooking elements 52 each has a hooked portion 521 at one end, and a connecting portion 522, which is formed by tightly winding the other end into a coil. The coil-like connecting portion 522 tapers towards one end. In assembly, the elastic cord portion 51 is passed through the connecting portions 522 of the hooking elements 52 at two ends. Then, two ends of the elastic cord portion 51 are each tightly passed through a ring 53 at least two times such that connecting ends 511 are provided to the elastic cord portion 51; the connecting ends 511 have convex surfaces 512 that are wider than the rings 53. And, the rings 53 have diameter bigger than the narrower ends of the connecting portions 522.

Thus, when the cord portion 51 is pulled further away from the hooking elements 52, the rings 53 will be held in position by the narrower ends of the connecting portions 522 of the hooking elements 52, preventing the cord portion 51 from falling off the hooking elements 52 as shown in FIG. 6. And, the connecting ends 511 will be partially received in the connecting portions 522.

However, it is found that the elastic cord has disadvantages as followings:

1. The coiled connecting portions 522 are likely to deform after long time of use due to the pulling force of the cord portion 51.

2. The connecting ends 511 of the cord portion 51 are likely to getting thinner and thinner after long time of use, and consequently fall off the rings 53, causing falling-off of the hooking elements 52 that is likely to hit the user or people in the vicinity. In addition, because the connecting ends 511 are not covered, they are likely to be damaged.

In using the elastic cord, referring to FIG. 7, the middle portion has to be tied around the frame of a luggage trolley 4, and the hooking elements 52 hooked onto the same after two half sections of the cord portion 51 is passed around the luggage. When the luggage has irregular shape, the user has to change the distance between the intermediate knot and two ends of the cord so that two sections of the cord each has a suitable length. However, it is not very convenient to change the position of the knob.

### SUMMARY OF THE INVENTION

Therefore, it is a main object of the present invention to provide a fastening elastic cord, which is equipped with hooking elements that can't easily fall off.

It is another object of the present invention to provide an adjusting member to the fastening cord such that a user can easily adjust the distance between ends of the cord and the joint of both the luggage trolley frame and the intermediate portion of the cord.

The fastening elastic cord includes an elastic cord portion, two end hooking elements, and a movable hooking element.

The hooking elements each has a holding portion, and a tube-shaped portion formed adjacent to the holding portion. The holding portions each has a lateral opening, and a through hole communicating with the tube-shaped portion. Two ends of the cord portion are passed through the tube-shaped portions and the through holes, and are formed with knots that are bigger than the through holes. The knots are protected with the respective holding portions so that they can't get damaged when the fastening cord is used. The movable hooking element is movably fitted around an intermediate portion of the cord portion at connecting portions thereof.

In addition, the hooking elements are each provided with a flexible plate capable of engaging the hooked portion to secure the connection of the hooking elements and the luggage trolley.

### BRIEF DESCRIPTION OF THE DRAWINGS

The present invention will be better understood by reference to the accompanying drawings, wherein:

FIG. 1 is a perspective view of the fastening elastic cord of the present invention.

FIG. 2 is a perspective view of the fastening elastic cord of the second embodiment of the present invention.

FIG. 3 is a cross-sectional view of the fastening elastic cord of FIG. 2.

FIG. 4 is a view illustrating the use of the fastening elastic cord of the second embodiment.

FIG. 5 is a fragmentary exploded perspective view of the prior fastening elastic cord as described in the Background.

FIG. 6 is a partial cross-sectional view of the prior fastening elastic cord.

FIG. 7 is a view illustrating the use of the prior fastening elastic cord.

### DETAILED DESCRIPTION OF THE PREFERRED EMBODIMENTS

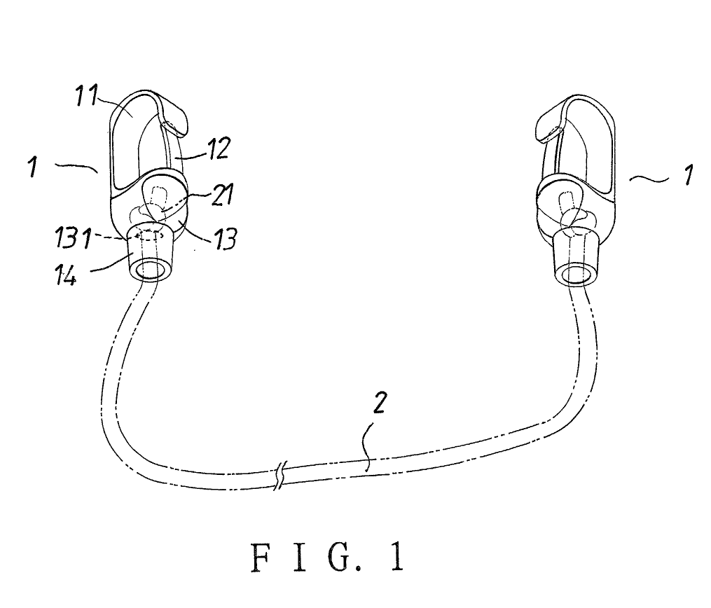

Referring to FIG. 1, a fastening elastic cord of the present invention includes an elastic cord portion 2, and a pair of hooking elements 1, 1. The hooking elements 1, 1 each has a hooked portion 11 at one end, and a holding portion 13 at the other end that is provided with a through hole 131, and a lateral opening (not numbered). In addition, the hooking elements 1, 1 are each formed with a tube-shaped portion 14 that is disposed around the through hole 131 of the holding portion 13. Furthermore, the hooking elements 1, and 1 are each provided with a flexible plate 12, which has a movable end capable of abutting the inner side of the hooked portion 11 for preventing the hooking element 1 from falling off when the hooking element 1 is hooked onto an object.

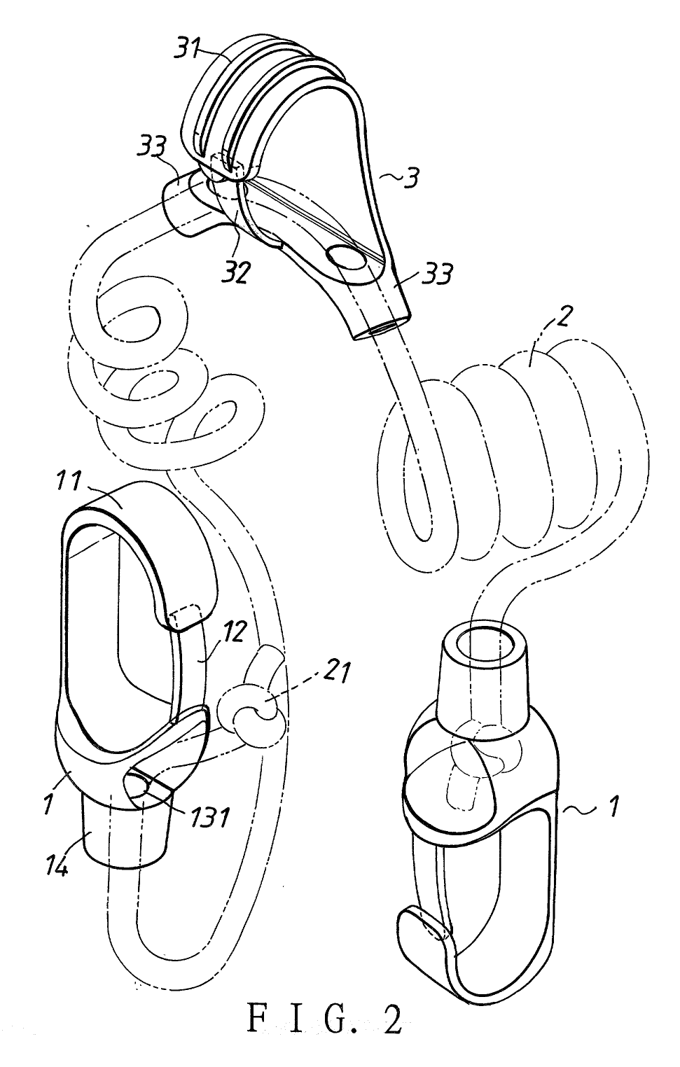

In assembly, referring to FIG. 2, two ends of the cord portion 2 are passed through the tube-shaped portions 14 of the hooking elements 1 as well as the through holes 131, and are formed with knots 21 that are bigger than the through holes 131. Thus, the knots 21 can be received in the respective holding portions 13 so as not to come into contact with other objects.

In using the fastening cord on a luggage trolley, one of the hooking elements 1 is hooked onto the frame of the trolley, and the cord portion 2 is wound around the luggage. Then, the other hooking element 1 is also hooked onto the frame.

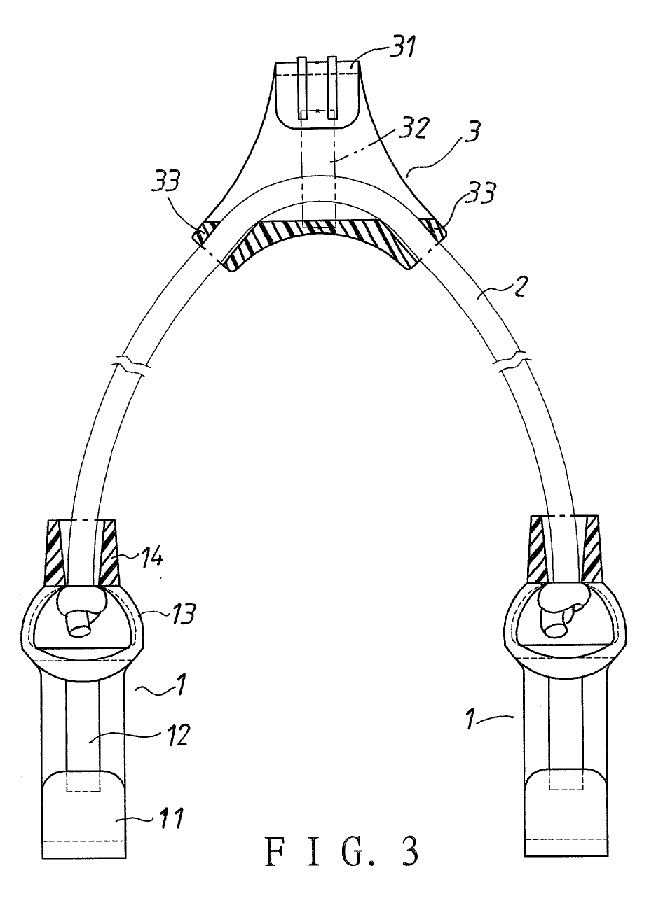

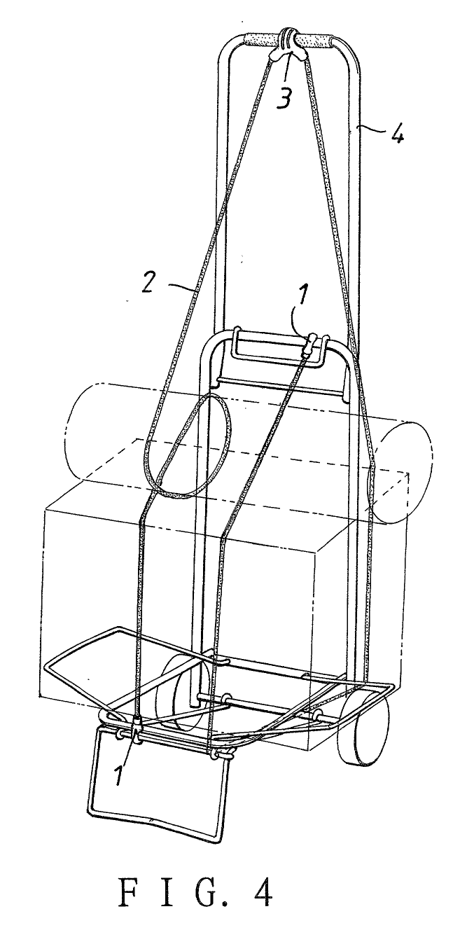

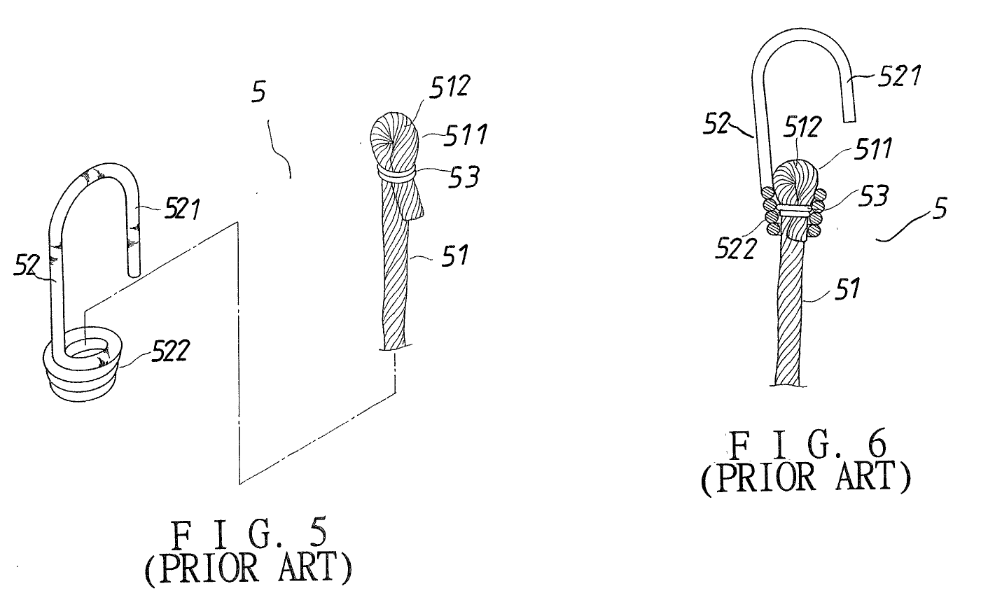

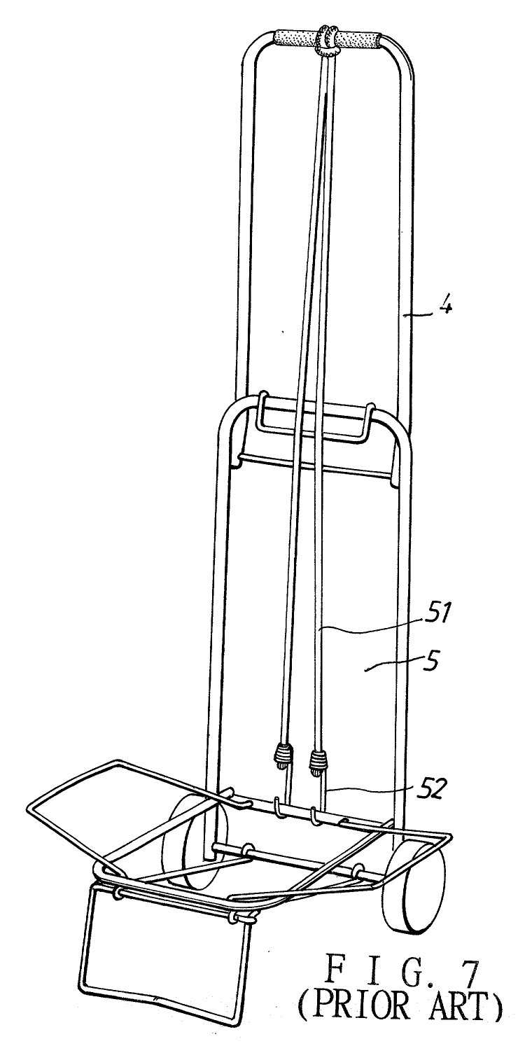

Referring to FIGS. 2 and 3, a fastening elastic cord of the second embodiment is provided with a movable hooking element 3 in addition to the last fastening elastic cord. The movable hooking element 3 also has a hooked portion 31, and a flexible plate 32, and is provided with two connecting tube-shaped portions 33. The cord portion 2 is passed through the tube-shaped portions 33 of the movable element 3 at the intermediate part so that the movable element 3 can be moved along the cord portion 2 for adjusting lengths of two sections of the cord portion 2 that extend from the tube-shaped portions 33. In using the fastening cord of the second embodiment, referring to FIG. 4, the movable hooking element 3 is hooked onto the frame of a luggage trolley 4, and the cord portion 2 is wound around the luggage, and the hooking elements 1 are hooked onto the frame so that the luggage is secured to the trolley.

From the above description, it can be easily understood that the fastening elastic cord of the present invention has advantages as followings:

1. The knots 21 of the cord portion 2 are formed such that they can't possibly fall off due to pulling force of the cord portion 2 on the hooking elements 1. And, the knots 21 can't get damaged because they are protected with the holding portions 13.

2. The movable hooking element 3 can be moved along the cord portion 2 for allowing two sections of the cord portion 2 to be easily adjusted in length. Therefore, the fastening cord can be easily used for fastening luggage that has irregular shape.

3. The flexible plates 12, 32 together with the hooked portions 11, 31 can enclose the frame, onto which the hooking elements 1, 3 are hooked, thus preventing the hooking elements 1, and 3 from falling off.

What is claimed is:

1. A fastening elastic cord, comprising
an elastic cord portion;
two hooking elements each having a hooked portion at one end; the hooking elements being each connected to one of two ends of the elastic portion;
and characterized by both a holding portion formed at other end of each of the hooking elements and a tube-shaped portion formed adjacent to each of the holding portions; the holding portions being each formed with a lateral opening, and a through hole communicating with the respective tube-shaped portion so that the ends of the cord portion can be passed into a respective one of the holding portions via the tube-shaped portions as well as the through holes with knots that are bigger than the through holes being made and held in the holding portions.

2. A fastening elastic cord of claim 1 further comprising a movable hooking element, which is provided with a hooked portion, and is movably fitted around an intermediate portion of the elastic cord portion at connecting portions thereof for adjusting lengths of two sections of the cord portion that extend from two ends of the movable hooking element.

3. The fastening elastic cord according to claims 1 or 2, wherein the hooking elements are each provided with a flexible plate capable of engaging the hooked portion for preventing the hooking element from falling off when the hooking element is hooked onto an object.
